(19) United States
(12) Patent Application Publication
(10) Pub. No.: US 2013/0111464 A1
(43) Pub. Date: May 2, 2013

(54) MODULAR AND OPEN PLATFORM IMAGE CAPTURE DEVICES AND RELATED METHODS

(71) Applicant: 3DMedia Corporation, Research Triangle Park, NC (US)

(72) Inventors: Tassos Markas, Chapel Hill, NC (US); Michael McNamer, Apex, NC (US); Heinz Seltmann, Cary, NC (US)

(73) Assignee: 3DMEDIA CORPORATION, Research Triangle Park, NC (US)

(21) Appl. No.: 13/662,443

(22) Filed: Oct. 27, 2012

Related U.S. Application Data
(60) Provisional application No. 61/552,126, filed on Oct. 27, 2011.

(51) Int. Cl. G06F 9/45; G06F 9/445

(52) U.S. Cl. CPC G06F 8/41; G06F 9/445
USPC 717/174; 717/140

(57) ABSTRACT

Disclosed herein are modular and open platform systems and related methods. In accordance with an aspect, a system may comprise multiple hardware subsystems configured to be selectively and operatively connected together. The system may include a main software module comprising multiple software sub-modules that each corresponds to one of the hardware subsystems. Each hardware subsystem may be configured to implement a target function. The system may also include one or more processors and memory configured to detect operative connection of one of the hardware subsystems. Further, the processor and memory may dynamically load the software sub-module that corresponds to the connected hardware subsystem into the main software module, and integrate the main software module with the loaded software sub-module for performing the target function associated with the corresponding hardware subsystem in response to detection of the operative connection.

### CROSS REFERENCE TO RELATED APPLICATION

This application claims the benefit of U.S. provisional patent application Ser. No. 61/552,126, filed Oct. 27, 2011, the disclosure of which is incorporated herein by reference in its entirety.

### TECHNICAL FIELD

The subject matter disclosed herein relates to systems and methods that involve a modular approach where different hardware and software modules performing different functions are connected together in a standard manner to create a fully-functional system and the definition of a hierarchical, easy to understand and easy to develop applications programming language that can complement the practical implementation of such modular systems.

### BACKGROUND

System design is a standard process and has been almost the same since its inception. Typically, system manufacturers will try to fit as many components as possible in area product volume to optimize for cost and size. This technique can result in a product that is optimized to perform a set of functions very well for a given price. However, consumers often demand different types of functionality and are willing to pay different prices for desired functions. These demands force system manufacturers to develop many different models, each targeting a specific price point and a specific set of functions, which results in high development costs and recurring manufacturing of similar products. In addition, in certain types of systems such as digital cameras or other image capture devices, the software that performs image/video processing cameras is fixed and targeted to a specific set of functions that are implemented on a given camera. A disadvantage is that users do not have the ability to augment the camera functionality either by using other third-party software or by developing their own software. Accordingly, for at least these reasons, there is a need to create a new model for designing system to accommodate user needs in terms of features, capabilities, price, as well as desired software and user interface.

### SUMMARY

Although the present disclosure can be applied to any system, the discussion is primarily focused on digital camera systems and smartphones. The selection of digital cameras and smartphones is more appropriate since they are one of the most complex systems since they various subsystems including, sensors, processors, lenses, image processing, user interfaces communication devices, and the like. It should be understood to those of skill in the art that the systems and methods in accordance with embodiments disclosed herein may be implemented in the same or a similar manner to any computing device.

The subject matter disclosed herein relates to systems and methods that involve a modular approach where different hardware and software modules performing different functions are connected together in a standard manner to create a fully-functional system. Each hardware module can be replaced with another module to augment functionality and customize the features of device system to match users' preferences. In addition, software customization platform may be provided to meet user needs. Further, the subject matter disclosed herein describes a method for designing software such that different software modules can be added or replaced by other ones performing different functions to augment the functionality of the system. Although the present disclosure provides examples and description related to camera systems and smartphones, as one of the most complicated designs to implement such concepts, the disclosure can easily be applied to any suitable system or computing device.

Modular and open platform image capture devices and related methods are disclosed herein. An image capture device, such as a digital camera, may include various subsystems interconnected in a single printed circuit board (PCB) or multiple PCBs. A PCB may include a number of integrated circuits (ICs) that can perform various functions. The types of the ICs, the image processing software performed by some of the ICs, as well as the optical properties of the camera, can determine the capabilities of the camera and ultimately its cost. There are hundreds of cameras introduced in the market every year to target a specific feature and price spot and to capture the attention of consumers willing to pay a given price for a specific set of features. Ultimately, every consumer has his or her own preference and will typically make a compromise on the features they want for the price they want to pay. In addition, the software on the cameras is fixed and the user interface is limited to what the manufacturer has designed. Although, there has been a significant improvement within user interface software, it is still something that is personal and should be left to the end user to modify and customize based on his or her own needs.

Cameras may include various subsystems such as, but not limited to, an optical subsystem, lens control modules, capture modules, the processing unit, communication modules, external interfaces, display and display controller, power module, flash light, and camera body. Such subsystems can be implemented by considering functionality and cost. Furthermore, cameras can also have communication modules to communicate with other devices using WIFI™ or cellular networks. Cameras and smartphones are converging at the low-end of the market and for the purpose of the present disclosure the presented concepts can also easily apply to smartphones. This complicates even more the camera design process. This can also contribute to why camera design is ultimately costly process, since all components in a camera need to be put together and tested.

In accordance with embodiments of the presently disclosed subject matter, modular image capturing devices are provided that have inter-connectable subsystems. By modularizing the design and partitioning the camera into various inter-connectable subsystems, an image capture device, such as a camera, can be built faster, more easily, and with less risk and development costs. Such a design process can also allow resulting cameras to fulfill more closely the requirements of each user. In addition, the resulting camera-buying process with interchangeable module can reduce electronic waste. Currently, to upgrade to a new functionality, consumers need to throwaway existing cameras and buy new ones, even if the new cameras only upgrade the functionality within a small portion of the existing cameras. Furthermore, with the advancements in three-dimensional (3D) printing technology even consumers or small-scale manufacturers can easily manufacture products, such as cameras and other electronic products by using the modular design concept and enclosing them in a camera body that has been created using components manufactured from 3D printers. The presently disclosed subject matter provides an approach that allows manufacturers to modularize their camera systems in a way that they can make their own cameras using a selection of available subsystems that have different capabilities at different price points. The software or computer-readable instructions implemented by the camera can also be modular to take full advantage of the underling architecture. Further, in accordance with the presently disclosed subject matter part of the camera and components may be reused to thereby minimize electronic waste and create a much environmentally-friendly camera market.

In accordance with embodiments, a system may comprise multiple hardware subsystems configured to be selectively and operatively connected together. The system may include a main software module comprising multiple software sub-modules that each corresponds to one of the hardware subsystems. Each hardware subsystem may be configured to implement a target function. The system may also include one or more processors and memory configured to detect operative connection of one of the hardware subsystems. Further, the processor and memory may dynamically load the software sub-module that corresponds to the connected hardware subsystem into the main software module, and integrate the main software module with the loaded software sub-module for performing the target function associated with the corresponding hardware subsystem in response to detection of the operative connection.

In accordance with embodiments, an image capture method may be implemented by at least one processor and memory configured to implement a main software module comprising a plurality of software sub-modules that each corresponds to one of the hardware subsystems. Each hardware subsystem is configured to implement a target function. The method may include detecting operative connection of one of the hardware subsystems. Further, the method may include dynamically loading the software sub-module that corresponds to the connected hardware subsystem into the main software module in response to detection of the operative connection. The method may also include integrating the main software module with the loaded software sub-module for performing the target function associated with the corresponding hardware subsystem in response to detection of the operative connection.

In accordance with embodiments, a method for developing an application on a computer system may include using a programming language comprising hierarchical definition and configured to manipulate objects. The method may also include using the programming language to manipulate actual objects. Further, the method may include using the programming language to define functions with multiple inputs parameters and multiple returning objects. The method may also include using the programming language to implement parallel processing to communicate between each other by passing objects. Further, the method may include using the programming language to implement processes and applications having a set of objects that can be made available to other processes and applications.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1A is a block diagram of an exemplary camera device in accordance with embodiments of the presently disclosed subject matter;

FIG. 1B is a flowchart of an example method for selectively and operatively connecting together hardware and software subsystems;

FIG. 2 is an assembly and fitting diagram of an example modular camera system in accordance with embodiments of the presently disclosed subject matter;

FIG. 3 is a block diagram of an example lens fitting process in accordance with embodiments of the presently disclosed subject matter;

FIG. 4 is a block diagram of an example lens subsystem in accordance with embodiments of the presently disclosed subject matter;

FIG. 5 is a block diagram of an example image capture subsystem in accordance with embodiments of the presently disclosed subject matter;

FIG. 6 is a block diagram of an example camera in accordance with embodiments of the presently disclosed subject matter;

FIG. 7 is a block diagram of an example peripheral subsystem in accordance with embodiments of the presently disclosed subject matter;

FIG. 8 is a block diagram of an example display subsystem in accordance with embodiments of the presently disclosed subject matter;

FIG. 9 is a block diagram of an example distributed power subsystem in accordance with embodiments of the presently disclosed subject matter;

FIG. 10 is a block diagram of an example software architecture in accordance with embodiments of the presently disclosed subject matter;

FIG. 11 is a block diagram of an example software framework in accordance with embodiments of the presently disclosed subject matter; and

FIG. 12 is a block diagram of an example software integration process in accordance with embodiments of the presently disclosed subject matter.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

While the embodiments have been described in connection with various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

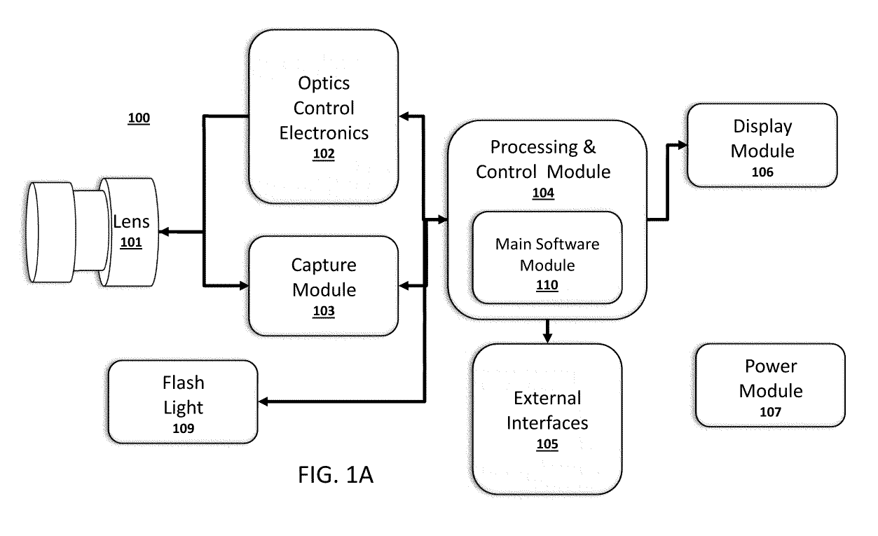

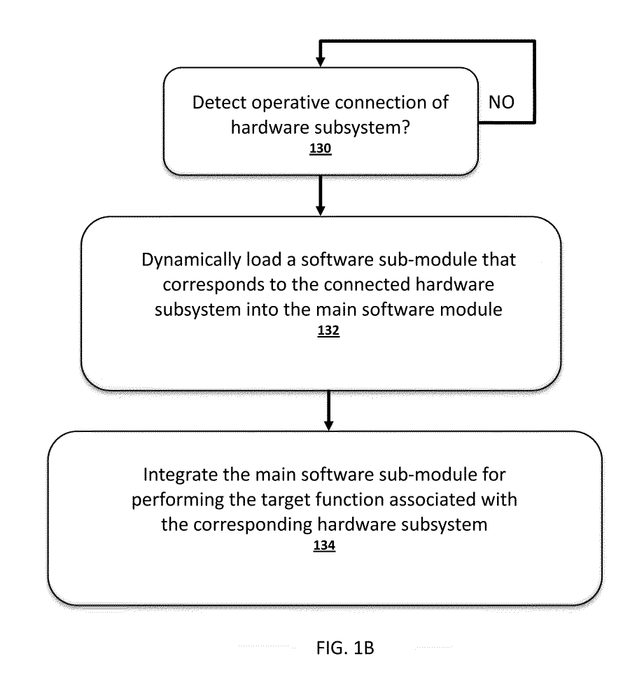

FIG. 1A illustrates a block diagram of an exemplary camera device 100 in accordance with embodiments of the presently disclosed subject matter. Referring to FIG. 1, the camera device 100 includes, but is not limited to, a lens 101, optics control electronics 102, a capture module 103, a processing and control module 104, external interfaces 105, a display module 106, a power module 107, and a flash light 109.

The camera device 100 may include various software sub-modules that each correspond to a hardware subsystem. It is noted that the term “sub-module” may be interchanged herein with the term “subsystem”. These sub-modules and subsystems are described in more detail herein. The hardware subsystems are configured to be selectively and operatively connected together.

In embodiments, FIG. 1B illustrates a flowchart of an example method for selectively and operatively connecting together hardware and software subsystems. The method may be implemented, for example, by the camera device 100 shown in FIG. 1. Further, for example, the module 104 may implement the steps of the example method 110 that includes one or more software sub-modules that each corresponds to one of multiple hardware subsystems.

The module 104 may implement a main software module 110 having multiple software sub-modules that each corresponds to one of the hardware subsystems. Each hardware subsystem is configured to implement a target function. A target function may be any function described herein for any of the hardware subsystems. It should be also noted that other subsystems may include their own processors with their own software modules that may run independently or in conjunction of the main software module 110. The main software module 110 may be the controlling module of the device and may initiate the execution of other software modules in the various subsystems. Other software modules can also start by themselves during system initialization. Software module can communicate with the main software module 110 using various means, such as but not limited to shared memory, shared connections, wireless communications, Internet, and the like.

Referring to FIG. 1B, the method includes detecting operative connection of a hardware subsystem (step 130). For example, the module 104 may detect whether a lens, such as lens 101, has been operatively connected to the camera device 100. The lens may be one of several lenses that can operatively connect to the camera device 100. The camera device 100 may include suitable hardware and/or software for detecting connection of the lens. If connection of a hardware subsystem is not detected, the method may continue to detection such connection.

In response to detecting operative connection of a hardware subsystem, the method includes dynamically loading a software sub-module that corresponds to the connected hardware subsystem into the main software module (step 132). Continuing the aforementioned example, the lens 101 can be operatively connected to the camera device 100. Further, the module 104 may receive signaling that indicates connection of the lens 101. In response to detecting the connection, the module 104 may dynamically load a software sub-module that corresponds to the lens 101 into the main software module. The software sub-module may be stored in memory of the camera device 100 or stored remotely. If the software sub-module is stored remotely, the camera device 101 may suitably retrieve the software sub-module from the remote memory or even the Internet.

Subsequent to step 132, the method includes integrating the main software module with the loaded software sub-module for performing the target function associated with the corresponding hardware subsystem (step 134). Continuing the aforementioned example, the module 104 may integrate the software sub-module of the lens 101 with the main software module for performing the image capture function associated with the lens 101.

In accordance with embodiments, hardware subsystems that can operatively connect with a device or system may be interchangeable with one or more other hardware subsystems for modifying one or more functions of the device or system. For example, the lens 101 may be interchanged with another type of lens for operation with the camera device 100. In response to operative connection of the other hardware subsystem, the connection may be detected and a corresponding software sub-module loaded and integrated with the main software module in accordance with embodiments of the present disclosure. Continuing the aforementioned example, when a suitable lens is operatively connected, the main software module and the connected lens can operate together to capture and process digital images and video.

In accordance with embodiments, a hardware subsystem may include an identification memory that defines functionality and types of integrated circuits in the hardware subsystem. In an example, the hardware subsystem may include integrated circuits having defined functionality. The module 104 may access the identification memory when connected to the hardware subsystem for use in selecting a software sub-module that corresponds to the hardware subsystem. The different hardware subsystems may be configured for separate operability.

In accordance with embodiments, a loaded software sub-module and its corresponding hardware subsystem may be an image capture system. The image capture system may include a user interface (e.g., display and its control) that is customized on connection on connection of the hardware subsystem and loading of the software sub-module.

In accordance with other embodiments in which an image capture system includes a loaded software sub-module and its corresponding hardware subsystem, the module 104 may determine whether the image capture system is connected to the Internet or another network. In response to determining that the image capture system is connected to the Internet or another network, the module 104 may automatically identify integrated subsystems with associated integrated circuits. Further, in response to determining that the image capture system is connected to the Internet or another network, the module 104 may automatically download drivers for the hardware. The drivers may be downloaded prior to implementing a building process. In an example, the hardware subsystem may include non-volatile memory that includes one or more device drivers for each integrated circuit on the corresponding hardware subsystem. The software sub-modules do not have to necessarily reside in the target system but can be identified and dynamically loaded from the internet without integrating them into the main software module. The system can discard the dynamically loaded software modules if they were loaded to only perform and specific function and this function is will not be necessarily needed in the future.

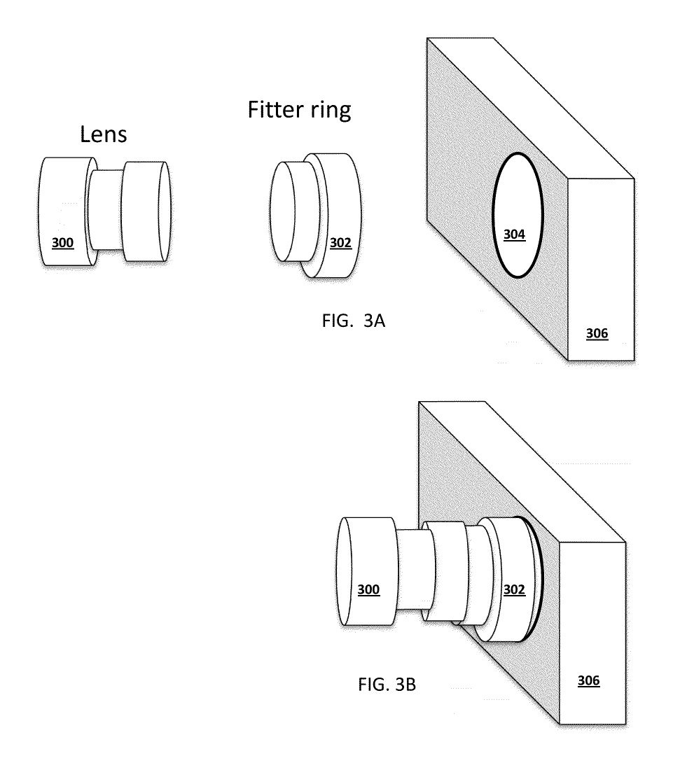

An example hardware subsystem is optics, which may include components that control the direction of the light of a captured scene. The optics may include, for example, the lens 101 and/or other lenses. Lenses can be either embedded or otherwise integrated into the camera device 100 or interchangeable. FIGS. 3A and 3B depict a diagram of an example lens fitting process in accordance with embodiments of the presently disclosed subject matter. This process is described in more detail herein. The optical subsystem can be either an interchangeable lens or a component embedded into the camera. In the latter case, as shown in FIGS. 3A and 3B for example, the lens can include two parts. Referring to FIG. 3A, one part is a lens assembly 300. The other part is a fitter ring 302 that can mount any suitable lens to an opening 304 of the camera body 306. FIG. 3B shows the parts being operatively connected for image capture.

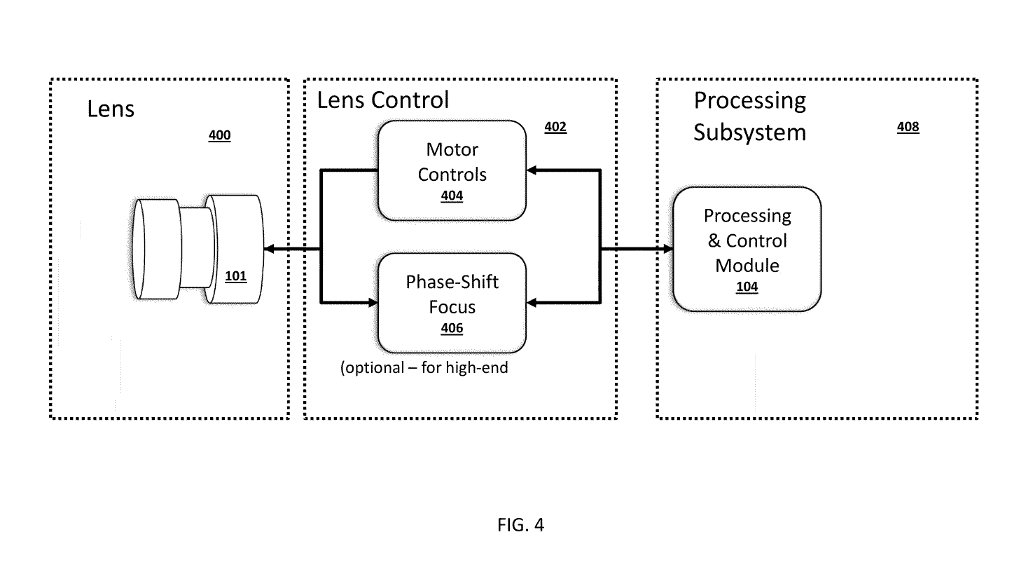

An example software subsystem includes a lens controller. The lens control module can have various options based on the capabilities and the desired performance of the camera. The functions of the lens control module can include, but are not limited to, focus, zooming, aperture control, and stabilization. The focus module can be based in either phase shift for high-end DSLRs or amplitude based for point-and-shoot cameras. Zooming and aperture control can be implemented by small motors that can be controlled by the CPU. The high-end module can also have motion stabilization capabilities. FIG. 4 shows an example of such a module.

The lens controller may include various software that operate together with a corresponding hardware subsystem, such as the optics control electronics 102, that controls a lens motor for controlling the zooming and focusing of the lens, such as the lens 101. FIG. 4 illustrates a block diagram of an example lens subsystem 400 in accordance with embodiments of the presently disclosed subject matter. Referring to FIG. 4, the lens subsystem is operatively connected to a lens control subsystem 402, which may include motor controls 404 and/or a phase-shift focus module 406. Further, the lens control subsystem 402 may be operatively connected to a processing subsystem 408. The subsystem 408 may include the module 104 in accordance with embodiments of the present disclosure.

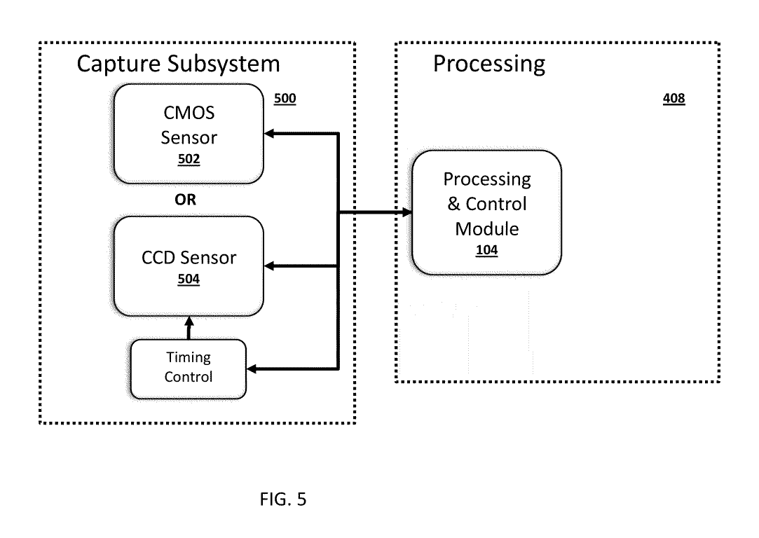

Another software subsystem and corresponding hardware subsystem includes an image capture subsystem. These subsystems are configured to allow the acquisition of light and can include a sensor and the electronics configured to receive a signal from the sensor and to communicate the signal to processing hardware and/or software, such as a suitable processor and memory. FIG. 5 illustrates a block diagram of an example image capture subsystem 500 in accordance with embodiments of the presently disclosed subject matter. Referring to FIG. 5, the image capture subsystem 500 may include a CMOS sensor 502 or a CCD sensor 504. Further, the subsystem 500 may include a timing control module 506. The capture subsystem may be operative connected to the processing subsystem 408 using a parallel or MIPI bus interface. Multiple sensors can also be included to capture three or more views of the scene to create three-dimensional or multi-dimensional images and/or video.

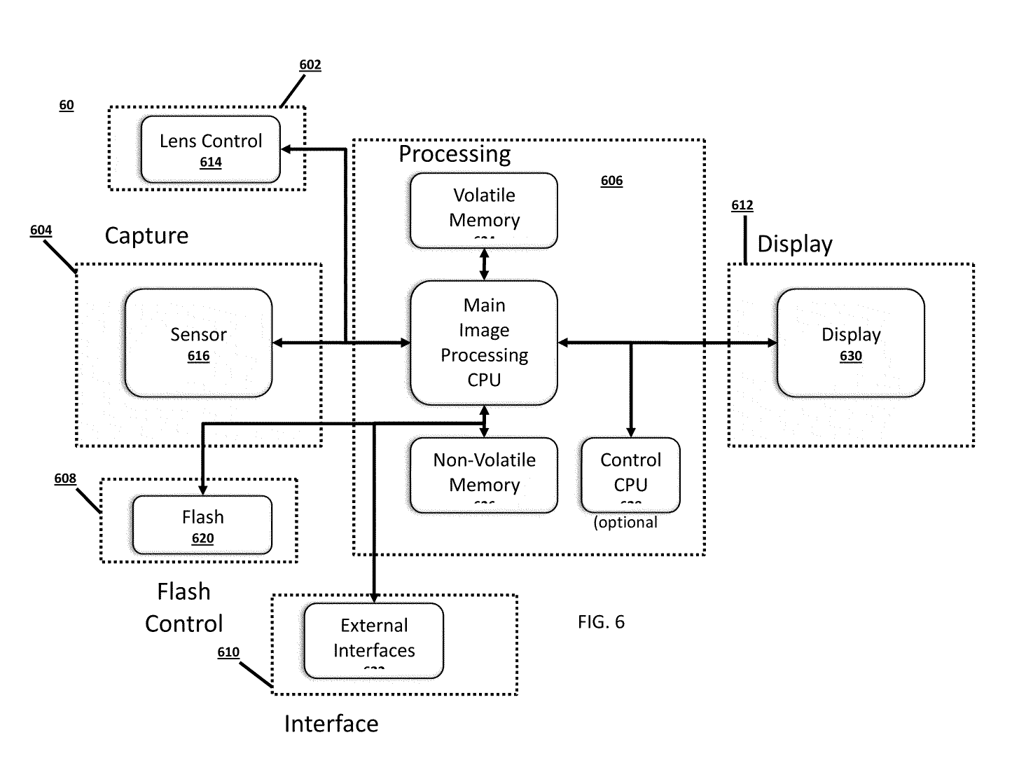

Another example hardware subsystem includes one or more processors and memory. This subsystem performs image processing, user interface, and control of a portion or the entirety of a camera. Processing can be handled by either a single central processing unit (CPU), or multiple CPUs that can be homogeneous or non-homogeneous in processing capabilities. Memory may operate in conjunction with one or more CPUs and may store temporary data. Software may reside on the memory and be loaded onto one or more of processors for suitable processing. FIG. 6 illustrates a block diagram of an example camera 600 in accordance with embodiments of the presently disclosed subject matter. Referring to FIG. 6, the camera 600 includes a lens control subsystem 602, an image capture subsystem 604, a processing subsystem 606, a flash control subsystem 608, an interface subsystem 610, and a display subsystem 612. The lens control subsystem 602 may include a lens control module 614 configured for operation with a sensor 616 of the image capture subsystem 604 and a CPU 618 of the processing subsystem 606. The flash control subsystem 608 may include a flash module 620. The interface subsystem 610 may include one or more external interfaces 622. The processing subsystem 606 may include volatile memory 624 such as SDRAM or DDR, non-volatile memory 626, and a control CPU module 628. The display subsystem 612 may include a display 630.

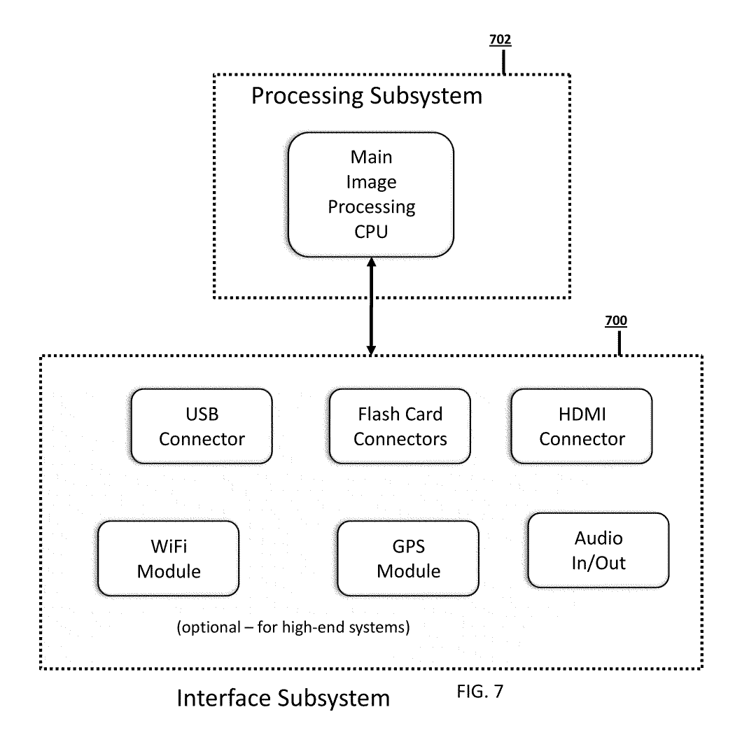

Yet another example hardware and software subsystem combination can be one or more interfaces. This module may include all or some of the functionality that enables the camera to communicate with outside devices, such as computing devices and other systems. These interfaces may provide connectivity for flash cards, USB, HDMI, WIFI™ for wireless connectivity, and GPS for position information of where a picture or sequence of pictures was captured. FIG. 7 illustrates a block diagram of an example peripheral interface subsystem 700 in accordance with embodiments of the presently disclosed subject matter. Referring to FIG. 7, the interface subsystem 700 includes multiple hardware subsystems such as, but not limited to, a USB connector, a WIFI™ module, flash card connectors, a GPS module, an HDMI connector, and an audio in/out module. The interface subsystem 700 is configured for operative connection to a processing subsystem 702 having a main image processing CPU 704.

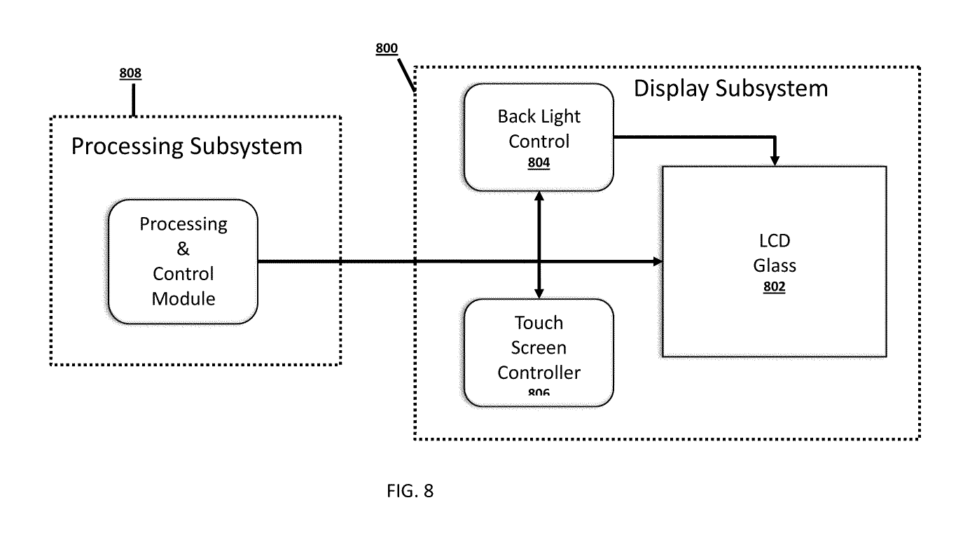

Another example hardware and software subsystem combination can be a display. Cameras typically have thin-film transistor, liquid crystal displays (TFT LCDs), but newer technologies such as OEM LEDs are gaining popularity. The LCD may typically connect to the main processor board with a standard connector. The size and resolution of the LCD may depend on the size of the selected body as well as the specific user requirements in terms of resolution and quality. A main feature of the display can be a touch-screen controller. Cameras can include many different buttons that are located in various positions. For a modular design, the location of the buttons may be either standardized, or buttons may be eliminated from devices. By use of a modular approach as disclosed herein, users may customize their user interface and define the functions that they prefer in a preferred location on the display screen. This subsystem allows users to view a scene that they are about to capture, previously-captured content, and/or various user interface functions. FIG. 8 illustrates a block diagram of an example display subsystem 800 in accordance with embodiments of the presently disclosed subject matter. Referring to FIG. 8, the display subsystem 800 may include an LCD glass 802, a back light control module 804, and a touch screen controller 806. The display subsystem 800 is configured for operative connection to a processing subsystem 808 having a processing and control module 810.

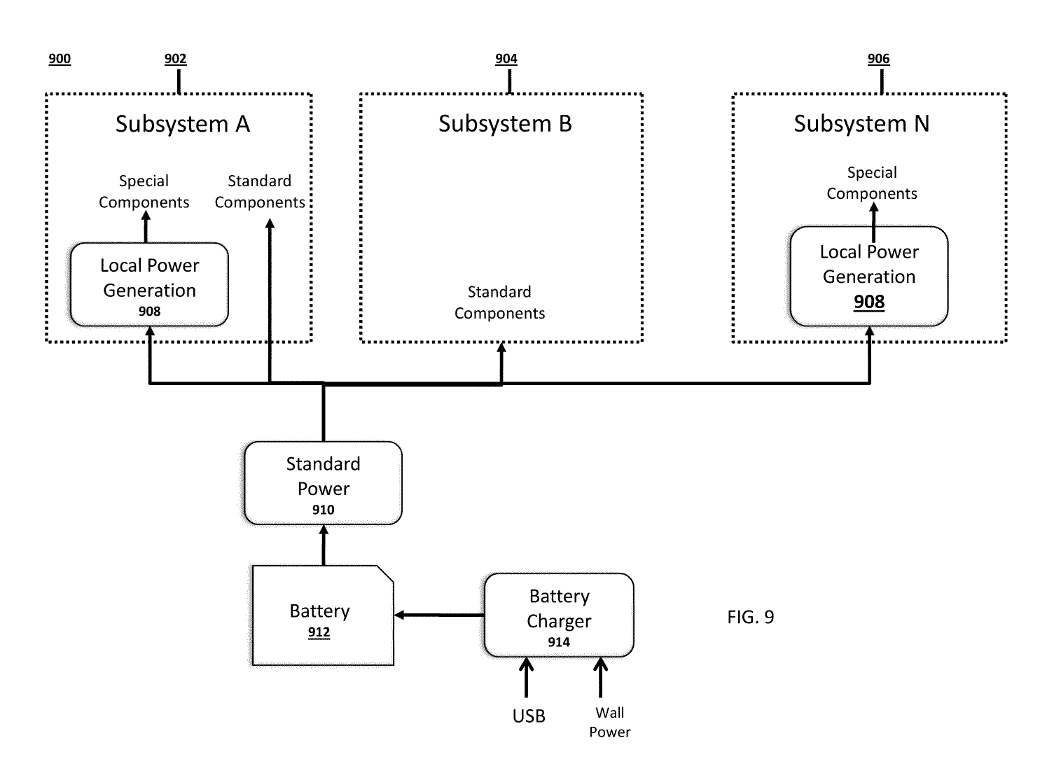

Another example hardware and software subsystem combination can be a power module. This subsystem supplies power to the entire unit and usually receives power from various types of batteries. Since many of the components have their own power requirement, the power design of the system may typically be implemented in a distributed fashion to minimize the power overhead of large or high-end components on high-end systems. Suitable power types and levels may be distributed to the system. Further, any additional power conversions/regulations can be implemented at the local level. In addition, there can be an optional battery charger from various sources. In the example of FIG. 9, subsystem A may take power from some components directly from the power module. Further, subsystem A may generate power for some local special components. By contrast, subsystem B may obtain power from the standard power only. Subsystem N may generate power locally for all ICs.

FIG. 9 illustrates a block diagram of an example distributed power subsystem 900 in accordance with embodiments of the presently disclosed subject matter. Referring to FIG. 9, the distributed power subsystem 900 includes subsystems A 902, B 904, to N 906. Each subsystem A 902, B 904, to N 906 may include a local power generation module 908, and may be operative connected to a central power module 910, a battery 912, and a battery charger 914.

Another example hardware and software subsystem combination can be a flashlight. The flashlight may include hardware and software configured to illuminate current surroundings to improve exposure conditions. A flashlight or strobe light module may have capabilities for internal or external flash light or both. Strobe lights can vary in terms of strength, mechanical design, location, and the like.

Another example hardware and software combination can be a body. For example, the body may include a camera housing that contains all described subsystems, and any additional subsystems not explicitly mentioned herein. The body can be assembled using pre-manufactured components using a mass production process or can be constructed utilizing 3D printers for smaller volume applications.

It is noted that a modular camera implementation can impose various restrictions upon system design to minimize the number of components that need to be designed for each particular subsystem. In addition, each of the modules may have optional components that can either be populated or not on the PCB to obtain the desired feature set or price point.

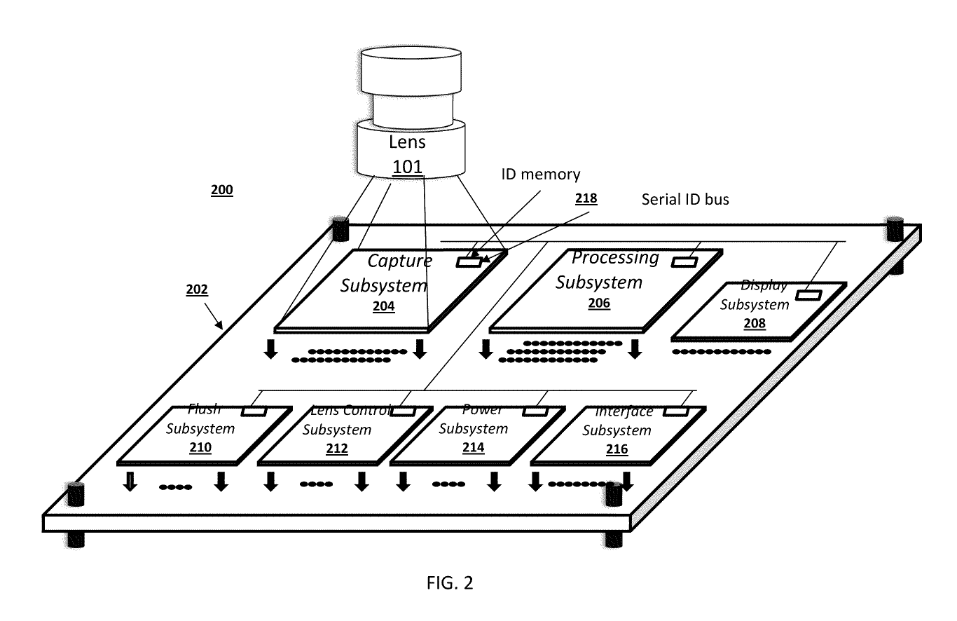

Based on the type of integrated circuits (ICs) that modules contain, they can have various numbers of PCB layers. For example, a module including the main CPU and memory is more likely to have 6 or even 8 layers of routing, whereas the power module can be done in 4 or even 2 levels of routing. Minimizing the number of routing layers within the modules, reduces the cost of the overall material which balances to a certain degree the cost of having multiple boards instead of only one. The modules can be interconnected together permanently using soldering material, high performance magnetic disks or rings, a clamp mechanism, flexible connectors, or a combination of the above to allow the users to make changes and updates to the final product by themselves. All connection mechanisms can be designed so they adhere to suitable standards to ensure interoperability among different hardware systems. A set of predefined connectors can be used to implement such system and also interface connectors and/or cables can be used to interconnect hardware subsystems with different interface connectors. For example, FIG. 2 illustrates an assembly and fitting diagram of an example modular camera system 200 in accordance with embodiments of the presently disclosed subject matter. Referring to FIG. 2, the system 200 includes a printed circuit board 202 having multiple ICs connected thereby. Particularly, the system 200 may include the following ICs or hardware subsystems: an image capture subsystem 204, a processing subsystem 206, a display subsystem 208, a flash subsystem 210, a lens control subsystem 212, a power subsystem 214, and an interface subsystem 216. Each subsystem may include an identification memory 218. In this example, the capture subsystem 204 is operatively connected to the lens 101. As disclosed herein, these hardware subsystems may be interchanged with other hardware subsystems. Further, these hardware subsystems may be operatively connected to the system 200 to result in the loading of a corresponding software sub-module for implementing a target function in accordance with embodiments of the present disclosure. Different polarity arrangement for magnets can suggest a specific orientation for the modules if such orientation enforcement is required by design. Also, the same magnets that hold the modules together may also be used to transfer power or other information between the modules. One or more hardware subsystems may be configured to support one or more integrated circuits.

In order to facilitate easy software integration, each subsystem can have an identification code that describes the functionality of the subsystem as well as the type of components that exist in the subsystem. The identification codes can be stored in a small non-volatile memory that is read during system initialization. The actual device driver code, which can be linked as a run-time library to the main code of the camera, can read the simple identification codes to determine the functionality of the subsystem and the part number of the ICs. A standard serial bus can be implemented into the system such that the main CPU can communicate with each subsystem's identification memory to receive information about ICs and subsystem.

Modularity techniques disclosed herein may require that subsystems fit easily to a limited number of standard camera bodies that may be supplied. Minimization of the number of offered standard camera bodies can be accomplished by determining a pre-assigned location for all main functions on the camera. On the right hand side for example, locations for the batteries as well as the interfaces to the external world may be provided. On the center and right side for example, optics and sensors may be provided. Further, at the top of the camera for example, a flashlight may be provided. The size of the batteries and the optics may be factors that determine the body type. There can be several body types for each camera market segment which include low/mid/high-end point-and-shoot cameras (PSs), mirrorless, and digital single-lens reflex (DSLRs). There can also be various esthetic elements that can be added to the body in a modular sense to make the design more appealing to consumers without having to incur tooling costs every-time another camera is made and designed. Those elements can include but are not limited to better materials, different shapes that alter the way a user handles the camera, body color, and the like. Body selection may be the last design element after all other functionality has been decided and completed.

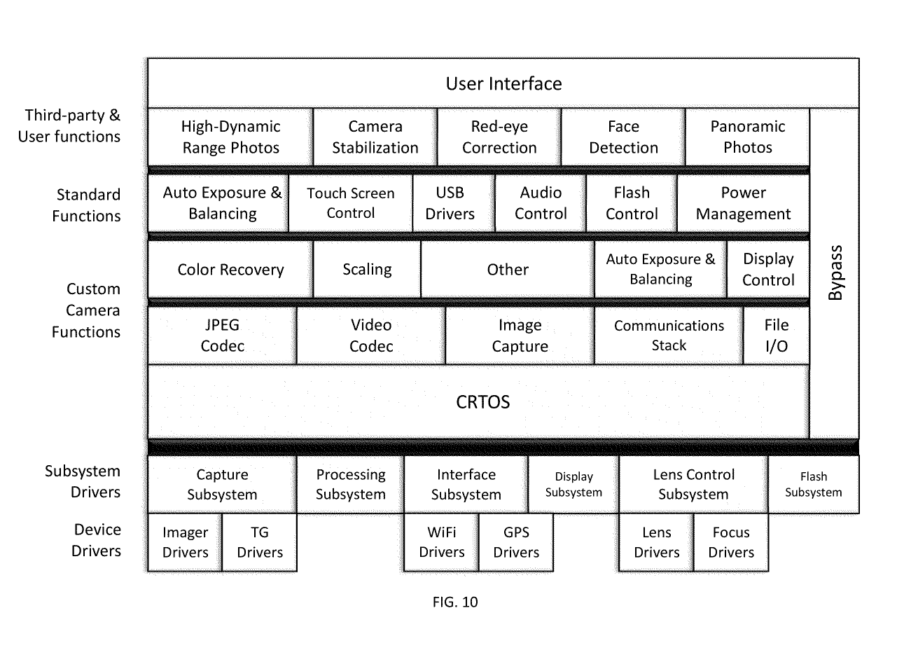

In accordance with embodiments, software may be designed in a modular manner. For example, FIG. 10 illustrates a block diagram of an example software architecture in accordance with embodiments of the presently disclosed subject matter. Embodiments of an open camera system are disclosed herein in accordance with the present subject matter. In some examples disclosed herein, users or integrators can design and provide software that performs different functions and that can be integrated into the camera's core software. The core function of the software is a camera-specific real-time operating system (CRTOS) that performs standard functions, and provides standard mechanisms of processers to communicate with each other. It may provide a base platform where special drivers specific to an IC reside below it and applications that perform various functions sit in top of it. The operating system may be sufficiently small to match the requirements of the market, but functional enough to support future capabilities that may be coming into the camera market, such as new connectivity and communication. The main controller software can be very generic. CRTOS does not need to understand how every camera subsystem works. It does however embrace the concept of media senders and receivers. Module applications may interface with these streams and take or receive data as needed. The CRTOS may also support an event-driven IO system. Existing open operating systems with or without modifications that satisfy those requirements can be used to support this platform. Each IC on the system may have a specific device driver, and there may be a standard communication protocol between the operating system and the device drivers of components that perform similar functions to facilitate quick integration of new hardware and software into the camera. In this case, when an IC provides new functionality that is not supported by the operating system, there can be different application procedural interfaces that allow direct connection to the device. Additions to the operating system may be made to incorporate new functionality while maintaining backwards compatibility.

On top of the operating system, there are specific camera functions that take advantage the hardware available on the processing ICs. Those functions can be either directly connected to the hardware, or they can reside as software implementations in case a different processing IC is used. On top of the specific camera functions, there are other standard functions that are common to camera platforms. On top of those functions, are the custom functions supported by manufacturers, integrators, third-party software houses, and eventually even the end-users. The top layer may be the user interface.

The user interface may be completely programmable and for the most part is implement using a touch-screen panel, although use of traditional buttons is also possible.

Standard tools can be designed to implement the user interface. This can include software tools that allow users to select from a predetermined set of objects, font, and color and implement a control flow of the entire process to build a custom user interface. This user interface (UI) builder may be part of the software platform. An important aspect of the UI builder is its ability to be to completely agnostic of the display size.

Currently, most of systems including cameras implement a fixed operation flow. This means that various processes or functions running on the system are executed in a fixed order determined by the main software module, thus preventing customization of the end application. Another import aspect of the UI builder can be to offer the ability to the users to change the processing flow of the software that is running on the various components and the main software module. For example, a user may want to perform a scaling operation on an image before applying a transformation to the image and vice-versa. The UI builder or any other software tool that is part of the framework can enable users to change the processing flow by presenting users the different functions and allowing them to change their processing order by connecting them together in the order of the desired execution.

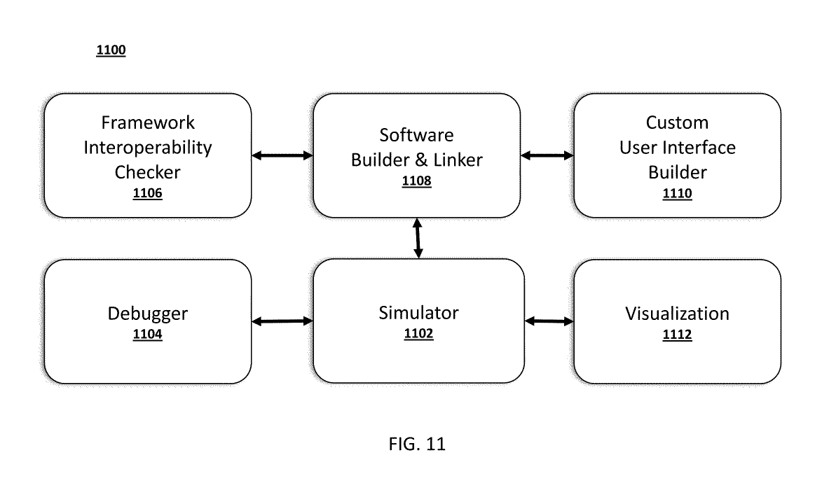

Once the camera has been assembled using various subsystems, the software may be built for the platform. This software can be part of more general suite of software tools that can assist with the development, testing, and qualification of functions as shown in the example of FIG. 11, which illustrates a block diagram of an example software framework 1100 in accordance with embodiments of the presently disclosed subject matter. For example in FIG. 11, a simulator 1102 can be implemented so developers can simulate the functionality of the system, qualify their software designs, and ensure interoperability within the software framework 1100. Other tools can include, but are not limited to, compilers, linkers, builders, debuggers and any other tools that can assist developers in this process. For example, the software framework 1100 include a debugger 1104, a framework interoperability checker 1106, a software building and linker 1108, a custom user interface builder 1110, and a visualization tool 1112. The software suite may also have visualization tools to show the results of various imaging processing modules. Developers of hardware modules can develop simulation modules that can be linked into the simulation environment and developers can use those simulation modules to evaluate a processing module and evaluate its performance before purchasing it.

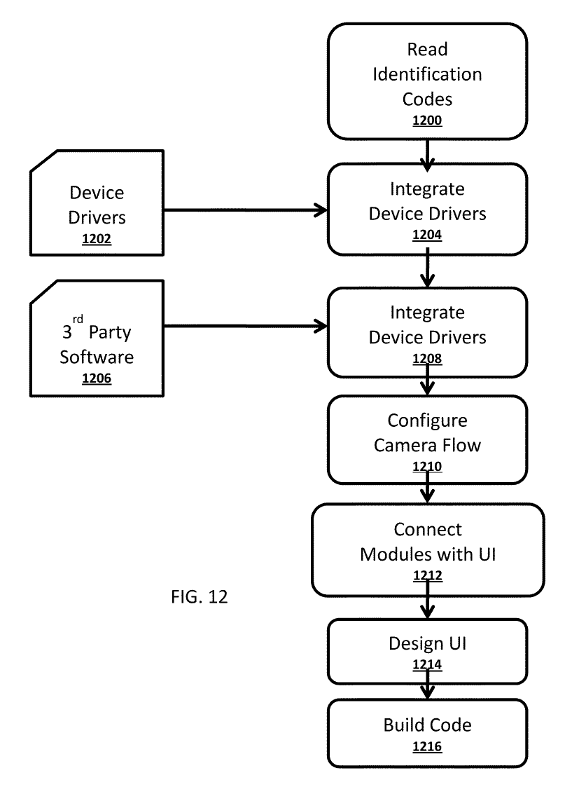

FIG. 12 is a block diagram of an example software integration process in accordance with embodiments of the presently disclosed subject matter. The camera may be connected to the PC using a USB cable or other interfaces. During boot up, the processor may read the identification codes from the subsystems (step 1200) and may download the proper drivers 1202 from the Internet or another suitable network. In case the code is already burned inside the subsystem, this process may not be necessary. The system can read the identification codes and can read the proper device drivers from the Internet or other media to integrate it into the software (step 1204). In addition, users or integrators may want to add to the pre-built other software 1206 supplied by third parties or developed by them. The third party software may then be integrated into the software (step 1208). The builder user interface can allow the developer to extract the desired modules from the Internet or other media and integrate them into the software. The UI builder can have a hierarchical construct where templates can be created using any combination of primitive symbols or other templates by themselves. If camera contains third-party software, users/integrators may need to decide where how to access the new functionality from the UI. The tool builder may identify such dependencies and may ask the user to provide those connections between software blocks. The builder may also allow users to create or configure their own flows (step 1210). For example, a user can define a flow where it first takes a picture, and subsequently it processes it to optimize and transmit over the Internet, and then opens a communication pipeline to send the picture to a photo-sharing site. In an example, this can happen with a click of a button. The user interface can be selected by a list of provided ones with option to customize (step 1212), or the user can opt to build it from scratch using the supplied UI builder (step 1214). Once some or all those pieces are assembled, the building process starts and the binary code may be generated that is stored in the non-volatile memory of the camera (step 1216).

The disclosed development environment can be also complemented with a simple, intuitive, easy to use language, but powerful enough to provide the maximum level of functionality and performance to the developers. A compiler can be used to convert the programming language to machine code for a target architecture. Although the discussion below will be focused on the language definition, the language and the compiler are tight together and whatever discussion is made regarding the language applies also to the compiler. The main scope of this language/compiler can be hierarchical definition of objects making it very easy to understand and implement applications. The starting point of such language can be one of various suitable programming languages such as C, C++, and the like with various augmentations to support a modern language capable facilitating an easy programming methodology with powerful yet simple constructs to accommodate the scope of the present disclosure.

Modifications of an existing programming language to satisfy the presented guidelines may include the elimination of pointers to objects that can make programming very difficult and can introduce memory management problems and memory leaks.

Although, object oriented languages have gain a lot of popularity recently, they have also introduced additional complexity with no significant good return on development of robust code. Concepts such as objects, their definition, and the processes applied can be part of this new language.

In this programming language, functions can accept a number of input parameters and can also produce a number of outputs to alleviate the single return parameter found in most languages today. This can make programming easier and more straightforward. Functions may only be defined only once. Currently, in many programming languages there are header files (i.e., .h) where functions with their parameters are declared forcing programming to define them in two different places (both on the header and source files). This makes their modification harder to do a more prone to errors that do not show up till compilation phase. A function can be automatically defined on the place where it is used.

The language can utilize abstract definitions of variables. The hierarchical nature of the language can allow the programming language to be as close as possible to the natural spoken language. For example, a function can be applied to the entire image defined using a variable such as I, a section of the image defined as I[0:512][0:10], a specific pixel color I[234][123][1], and the like. The compiler can recognize those new constructs and generate the proper code to accommodate with this user input directives. An image can also be represented as a generalized image object that besides the image data can contain other ancillary information that indicate but not limited to capture information of the image, parameters, geographic location of the captured image, and the like as well as possible ways to manipulate the image or extract information from the generalized image object. Such information may be stored stored in the EXIF headers in JPG container that contains compressed image information. Operators can be applied to the entire objects or parts of the object. For example, if I1.jpg and I2.jpg are two .JPG files, read an image read operator, and write an image write operator, the following operations can cause the pixel of the two images to be added to each other thus creating a new image I3 and write it to new file I3.jpg

I1=read(“I1.jpg”); I2=read(“I2.jpg”); I3=I1+I2; write(I3, “I3.jpg”);

The language can be smart enough to understand that a .jpg file is a compressed image file that complies to the JPG file format guidelines, thus eliminating the need for the user to understand what type of read and write operations to use. In addition, definitions on how to parse a type of data can be inserted in the header of any new file format. The language can parse the headers to understand how to manipulate the data on the container and assign the proper variables and parameters to handle them.

The hierarchical nature of the language can allow easy manipulation of parts of the generalized object. For example the construct I1[:][:][red] refers to all red pixels of an image, or a video object V1[2:45][:][1][blue] refers to all blue pixels in row one in frames 2 through 45.

The language may also include self-interpretation of the types of variables used. For example, in the previous references I1 does not need to be defined as an image variable. The statement I1=read(“I1.jpg”) implies that the created variable is in image and it does not have to be declared as image anywhere in the program. In another example a statement v=8 can self imply that variable v is an unsigned char since it can fit within 0-256. Or and operation of c=v*34.56 will imply that the variable c is floating point number since this is the container that can fit the result of the operation v*34.56. The type of a variable can be also modified during compilation or even program execution. For example the operation v=0.45; will change the implied definition of the variable v from unsigned character to a floating point number. Types can also be defined to reduce memory requirements in embedded systems. For example the operation z=integer(v) can allocate a integer type to the memory for variable z and can assign to it the integer part of the v variable.

The language may include the definition of new operators. Those operators can replace the definition of functions that may be too cumbersome to use in certain cases. For example, a “combine” operator can be defined to combine the values of two arrays as in: a=min(array1 combine array2). With this operation, arrays 1 and 2 will be combined in one array and the minimum value of both arrays will be identified and assigned on the variable a. Any operator can also be substituted by a different string to create a language that is as close as possible to human written language, thus making it easier to understand and program with. For example, the programming statement “a=b+(c>>1);” can be substituted with “a equals to b plus (c shift left by 1 position);”. Supporting tools can be also used to convert the language back to its formal definition or vice versa.

The language may include the capability to perform parallel execution of functions using multi-threading principles. Multi-threading principles should be simple enough to define, powerful enough however to implement maximum efficiency and system performance. Threads can communicate between each other using simple message passing variables that indicate what a process should do in case of a specific event. For example, a process can define a structure or an object with the parameters or events that can pass to other processes. It can additionally, have the ability to restrict use of its parameters from other functions/processes. Another process, provided it has the proper permissions, can inquire the parameters/events of the generating process to take certain types of actions.

Language can also have memory management capabilities to prevent processes corrupting memory of other processes. Each application can have its own private memory with private data that cannot be accessed by other applications, as well as external data that can be accessed by other applications. In the latter case, the application that generates and controls the external data can have the ability to restrict types of use. In addition, an application can create a group of applications or users that have the ability to access external data.

Language can have also the capabilities to support specialized hardware to increase execution performance. Specialized processors can include identical multiprocessing units that can either run simultaneously same instructions on different data (i.e., Single Instruction Multiple Data) or different instructions on different data (i.e., Multiple Instructions on Multiple Data). Scheduling of those instructions can be implemented manually by the developers or using optimizing compilers that can do the scheduling automatically.

In an example implementation of the programming language, the programming language in conjunction with its compiler may include a hierarchical definition. Further, the programming language may be configured to manipulate objects. The programming language may also be used to manipulate actual objects. Further, the programming language may be used to define functions with multiple input parameters and multiple returning objects. The programming language may be used to implement parallel processing to communicate between each other by passing objects. Further, the programming language may be used to implement processes and applications having a set of objects that can be made available to other processes and applications. In an example, the programming language may be used to implement processes and objects to perform memory management in a predetermined transparent manner and to avoid memory leaks. Further, the programming language may provide constructs such that a function can be implemented in hardware architecture offering customized hardware to accelerate a single function, and/or break a function into multiple components and run each component in a predetermined hardware unit available in a hardware architecture.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the processing of the present invention.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A system comprising a plurality of hardware subsystems configured to be selectively and operatively connected together, the system comprising:
a main software module comprising a plurality of software sub-modules that each corresponds to one of the hardware subsystems, wherein each hardware subsystem is configured to implement a target function; and
at least a processor and memory configured to:
detect operative connection of one of the hardware subsystems; and
in response to detection of the operative connection:
dynamically load the software sub-module that corresponds to the connected hardware subsystem into the main software module; and
integrate the main software module with the loaded software sub-module for performing the target function associated with the corresponding hardware subsystem.

2. The system of claim 1, wherein each hardware subsystem is configured to be interchanged by a different one of the hardware subsystems for modifying one or more functions of the system.

3. The system of claim 1, wherein each hardware subsystem is configured to support a plurality of integrated circuits.

4. The system of claim 1, wherein each hardware subsystem comprises an identification memory that defines functionality and types of integrated circuits in the hardware subsystem.

5. The system of claim 1, wherein the main software module and at least one of the hardware subsystems are configured to capture and process digital images and video.

6. The system of claim 1, wherein the hardware subsystems are configured for separate interoperability.

7. The system of claim 1, wherein the hardware subsystems are configured to implement an image capture device.

8. A method implemented by at least one processor and memory configured to implement a main software module comprising a plurality of software sub-modules that each corresponds to one of the hardware subsystems, wherein each hardware subsystem is configured to implement a target function, the method comprising:
using the at least one processor and memory for:
detecting operative connection of one of the hardware subsystems; and
in response to detection of the operative connection:
dynamically loading the software sub-module that corresponds to the connected hardware subsystem into the main software module; and
integrating the main software module with the loaded software sub-module for performing the target function associated with the corresponding hardware subsystem.

9. The method of claim 8, further comprising loading one or more other software sub-modules.

10. The method of claim 8, further comprising customizing a user interface of the system.

11. The method of claim 8, further comprising
determining whether the system is connected to the Internet; and
in response to determining that system is connected to the Internet:
automatically identifying integrated subsystems with associated integrated circuits; and
automatically downloading drivers prior to implementing a building process.

12. The method of claim 8, wherein each hardware subsystem comprises non-volatile memory that includes at least one device driver for each integrated circuit on the corresponding hardware subsystem.

13. The method of claim 8, wherein the at least one processor and memory is configured to implement allow a user to modify an operational flow of the system.

14. The method of claim 8, wherein the steps are implemented in an image capture device.

15. A method for developing an application on a computer system, the method comprising:
using a programming environment comprising of a programming language enabling the use of abstract and hierarchically defined objects and its associated compiler, to the programming environment capable of:
understanding types of variables absent explicit specification of their types;
understanding the types of specified operators and identifying the proper objects or parts of objects where operators need to be applied;
translating the directives in programming language to machine code for the target platform; and
executing the machine code in the target platform to manipulate actual objects as well as parts of objects.

16. The method of claim 15, further comprising using the programming environment to implement processes and objects to perform memory management in a predetermined transparent manner and to avoid memory leaks.

17. The method of claim 15, wherein the programming environment is configured to provide constructs such that a function can be implemented in hardware architecture offering customized hardware to one of accelerate a single function, and break a function into multiple components and run each component in a predetermined hardware unit available in a hardware architecture.

18. The method of claim 15, further comprising using the programming environment to define and utilize functions with multiple inputs parameters and multiple returning objects.

19. The method of claim 15, further comprising using the programming environment to implement parallel processing.

20. The method of claim 19, further comprising using the programming language to enable communication among processes running in parallel by passing objects.

21. The method of claim 15, further comprising using the programming environment to define new operators to manipulate objects.

22. The method of claim 15, further comprising using the programming environment to one of rename and redefine standard operators.
